(19) United States
(12) Patent Application Publication
(10) Pub. No.: US 2024/0387986 A1
(43) Pub. Date: Nov. 21, 2024

(54) FLEXIBLE ANTENNA STRUCTURE

(71) Applicants: Yun-Chan Tsai, Taipei City (TW); ONEWAVE TECHNOLOGY CO., LTD., Taipei City (TW)

(72) Inventors: Yun-Chan TSAI, Taipei City (TW); Po-Huai HUANG, Taipei City (TW); Shi-Hong YANG, Taipei City (TW); Shi-Yu CHIU, Taipei City (TW)

(21) Appl. No.: 18/197,516

(22) Filed: May 15, 2023

(51) Int. Cl. H01Q 1/38; H01Q 1/50

(52) U.S. Cl. CPC H01Q 1/38; H01Q 1/50

(57) ABSTRACT

A flexible antenna structure includes a soft board, a first hard board, a soft antenna circuit and an antenna substructure. Moreover, the first hard board is arranged on the soft board. The soft antenna circuit is arranged on the soft board. The antenna substructure is arranged on the first hard board or is defined in the first hard board.

### BACKGROUND OF THE DISCLOSURE

### Technical Field

The present disclosure relates to an antenna structure, and especially relates to a flexible antenna structure.

### Description of Related Art

Wireless communication products all have antennas to transmit and receive wireless signals. With the rapid development of science and technology, many new technologies and new communication protocols have been proposed, such as WI-FI 5, Wi-Fi 6 and 5G, so that the wireless communication products need to wirelessly transmit and receive more and more information, and so that the antenna structures of the wireless communication products become more and more complex and are difficult to be arranged in the housings of the wireless communication products.

### SUMMARY OF THE DISCLOSURE

In order to solve the above-mentioned problems, an object of the present disclosure is to provide a flexible antenna structure.

In order to achieve the object of the present disclosure mentioned above, the flexible antenna structure of the present disclosure includes a soft board, a first hard board, a soft antenna circuit and an antenna substructure. The first hard board is arranged on the soft board. The soft antenna circuit is arranged on the soft board. The antenna substructure is arranged on the first hard board or is defined/arranged in the first hard board.

Moreover, in an embodiment of the flexible antenna structure of the present disclosure mentioned above, the antenna substructure is an antenna circuit arranged on the first hard board.

Moreover, in an embodiment of the flexible antenna structure of the present disclosure mentioned above, the soft board includes a plurality of first bonding pads. The first hard board includes a plurality of second bonding pads. The first bonding pads are soldered to the second bonding pads.

Moreover, in an embodiment of the flexible antenna structure of the present disclosure mentioned above, the flexible antenna structure further includes a second hard board arranged on the soft board. Moreover, a first thickness of the first hard board is equal to a second thickness of the second hard board.

Moreover, in an embodiment of the flexible antenna structure of the present disclosure mentioned above, the flexible antenna structure further includes a second hard board arranged on the soft board. Moreover, the antenna substructure includes a plurality of first via holes defined in the first hard board, the soft board and the second hard board to be through the first hard board, the soft board and the second hard board.

Moreover, in an embodiment of the flexible antenna structure of the present disclosure mentioned above, the antenna substructure further includes an antenna circuit arranged on the first hard board.

Moreover, in an embodiment of the flexible antenna structure of the present disclosure mentioned above, a first thickness of the first hard board is equal to a second thickness of the second hard board.

Moreover, in an embodiment of the flexible antenna structure of the present disclosure mentioned above, the flexible antenna structure further includes a second hard board arranged on the soft board. Moreover, the antenna substructure includes a plurality of first via holes defined in the first hard board. Moreover, the second hard board defines a plurality of second via holes.

Moreover, in an embodiment of the flexible antenna structure of the present disclosure mentioned above, the antenna substructure further includes an antenna circuit arranged on the first hard board.

Moreover, in an embodiment of the flexible antenna structure of the present disclosure mentioned above, a first thickness of the first hard board is different from a second thickness of the second hard board.

Moreover, in an embodiment of the flexible antenna structure of the present disclosure mentioned above, the soft board is bent and shaped at any angle.

Moreover, in an embodiment of the flexible antenna structure of the present disclosure mentioned above, the flexible antenna structure further includes a parallelly-extended soft board and a first extended soft antenna circuit. The parallelly-extended soft board is connected to the soft board to extend parallelly from the soft board. The first extended soft antenna circuit is arranged on the parallelly-extended soft board.

Moreover, in an embodiment of the flexible antenna structure of the present disclosure mentioned above, the soft board and the parallelly-extended soft board are bent and shaped at any angle.

Moreover, in an embodiment of the flexible antenna structure of the present disclosure mentioned above, the flexible antenna structure further includes a first vertically-extended soft board, a first extended soft antenna circuit, a second vertically-extended soft board and a second extended soft antenna circuit. The first vertically-extended soft board is connected to the soft board to extend vertically from the soft board. The first extended soft antenna circuit is arranged on the first vertically-extended soft board. The second vertically-extended soft board is connected to the soft board to extend vertically from the soft board. The second extended soft antenna circuit is arranged on the second vertically-extended soft board. Moreover, the soft board, the first vertically-extended soft board and the second vertically-extended soft board are T-shaped; namely, the soft board, the first vertically-extended soft board and the second vertically-extended soft board together form a T shape.

Moreover, in an embodiment of the flexible antenna structure of the present disclosure mentioned above, the soft board, the first vertically-extended soft board and the second vertically-extended soft board are bent and shaped at any angle.

Moreover, in an embodiment of the flexible antenna structure of the present disclosure mentioned above, the flexible antenna structure further includes a direct plug structure connected to the first hard board.

Moreover, in an embodiment of the flexible antenna structure of the present disclosure mentioned above, the direct plug structure is U-shaped.

The advantage of the present disclosure is that the antenna structure is simple, flexible and easy to arrange, wherein the soft board and the antenna circuit arranged on the soft board are flexible.

Please refer to the detailed descriptions and figures of the present disclosure mentioned below for further understanding the technology, method and effect of the present disclosure achieving the predetermined purposes. It believes that the purposes, characteristic and features of the present disclosure can be understood deeply and specifically. However, the figures are only for references and descriptions, but the present disclosure is not limited by the figures.

### BRIEF DESCRIPTION OF THE DRAWINGS

FIG. 1 shows a combined perspective view of the first embodiment of the flexible antenna structure of the present disclosure.

FIG. 2 shows an exploded view of the first embodiment of the flexible antenna structure of the present disclosure.

FIG. 3 shows a combined perspective view of the second embodiment of the flexible antenna structure of the present disclosure.

FIG. 4 shows an exploded view of the second embodiment of the flexible antenna structure of the present disclosure.

FIG. 5 shows a combined perspective view of the third embodiment of the flexible antenna structure of the present disclosure.

FIG. 6 shows an exploded view of the third embodiment of the flexible antenna structure of the present disclosure.

FIG. 7 shows a combined perspective view of the fourth embodiment of the flexible antenna structure of the present disclosure.

FIG. 8 shows a side sectional view of the fourth embodiment of the flexible antenna structure of the present disclosure.

FIG. 9 shows a combined perspective view of the fifth embodiment of the flexible antenna structure of the present disclosure.

FIG. 10 shows a side sectional view of the fifth embodiment of the flexible antenna structure of the present disclosure.

FIG. 11 shows a combined perspective view of the sixth embodiment of the flexible antenna structure of the present disclosure.

FIG. 12 shows an exploded view of the seventh embodiment of the flexible antenna structure of the present disclosure.

FIG. 13 shows an exploded view of the eighth embodiment of the flexible antenna structure of the present disclosure.

FIG. 14 shows a schematic diagram of the soft board being bent in the first embodiment of the flexible antenna structure of the present disclosure.

FIG. 15 shows another schematic diagram of the soft board being bent in the first embodiment of the flexible antenna structure of the present disclosure.

FIG. 16 shows a schematic diagram of the soft board and the parallelly-extended soft board being bent in the seventh embodiment of the flexible antenna structure of the present disclosure.

FIG. 17 shows another schematic diagram of the soft board and the parallelly-extended soft board being bent in the seventh embodiment of the flexible antenna structure of the present disclosure.

FIG. 18 shows a schematic diagram of the soft board, the first vertically-extended soft board and the second vertically-extended soft board being bent in the eighth embodiment of the flexible antenna structure of the present disclosure.

FIG. 19 shows another schematic diagram of the soft board, the first vertically-extended soft board and the second vertically-extended soft board being bent in the eighth embodiment of the flexible antenna structure of the present disclosure.

FIG. 20 shows a combined perspective view of the ninth embodiment of the flexible antenna structure of the present disclosure.

FIG. 21 shows a combined perspective view of the tenth embodiment of the flexible antenna structure of the present disclosure.

FIG. 22 shows a combined perspective view of the eleventh embodiment of the flexible antenna structure of the present disclosure.

FIG. 23 shows a schematic diagram of the soft board being bent in the ninth embodiment of the flexible antenna structure of the present disclosure.

FIG. 24 shows another schematic diagram of the soft board being bent in the ninth embodiment of the flexible antenna structure of the present disclosure.

FIG. 25 shows a schematic diagram of the soft board and the parallelly-extended soft board being bent in the tenth embodiment of the flexible antenna structure of the present disclosure.

FIG. 26 shows another schematic diagram of the soft board and the parallelly-extended soft board being bent in the tenth embodiment of the flexible antenna structure of the present disclosure.

FIG. 27 shows a schematic diagram of the soft board, the first vertically-extended soft board and the second vertically-extended soft board being bent in the eleventh embodiment of the flexible antenna structure of the present disclosure.

FIG. 28 shows another schematic diagram of the soft board, the first vertically-extended soft board and the second vertically-extended soft board being bent in the eleventh embodiment of the flexible antenna structure of the present disclosure.

### DETAILED DESCRIPTION

In the present disclosure, numerous specific details are provided, to provide a thorough understanding of embodiments of the disclosure. Persons of ordinary skill in the art will recognize, however, that the present disclosure can be practiced without one or more of the specific details. In other instances, well-known details are not shown or described to avoid obscuring aspects of the present disclosure. Now please refer to the figures for the explanation of the technical content and the detailed description of the present disclosure:

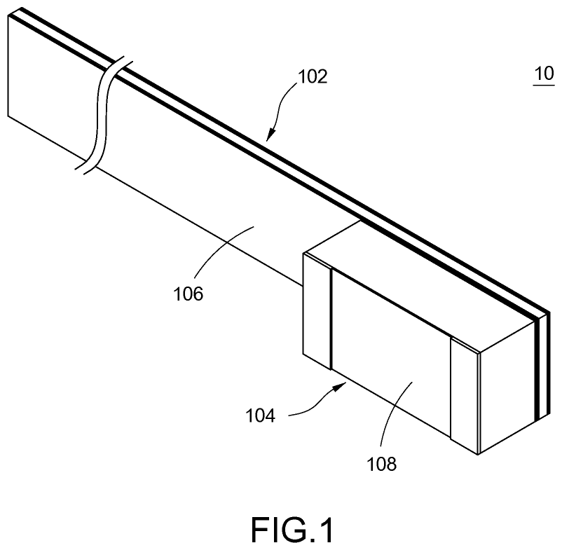

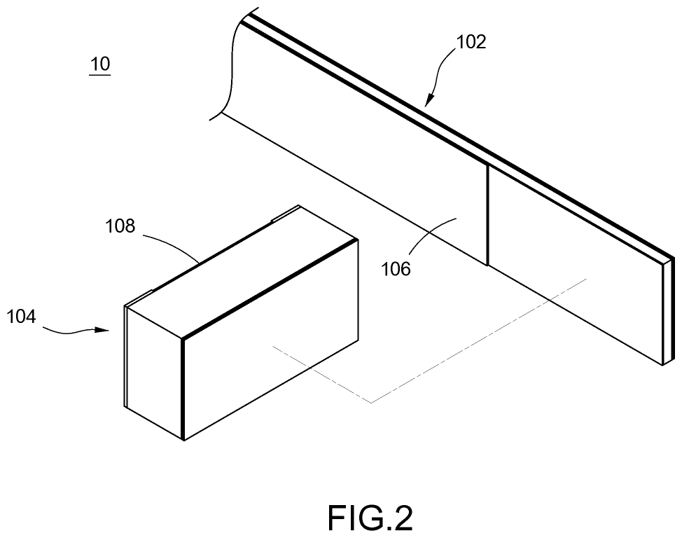

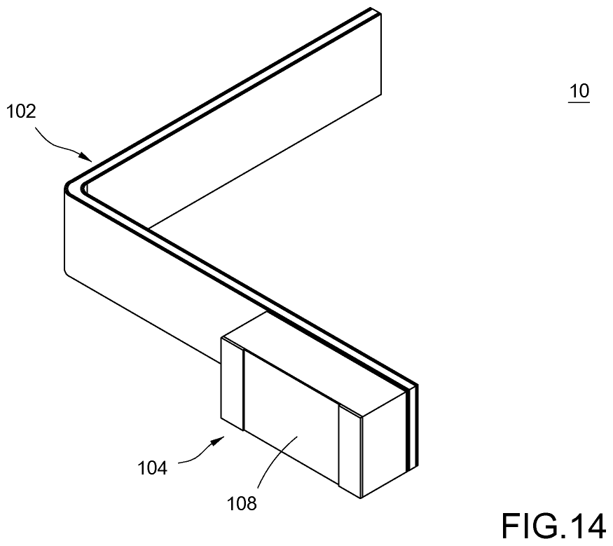

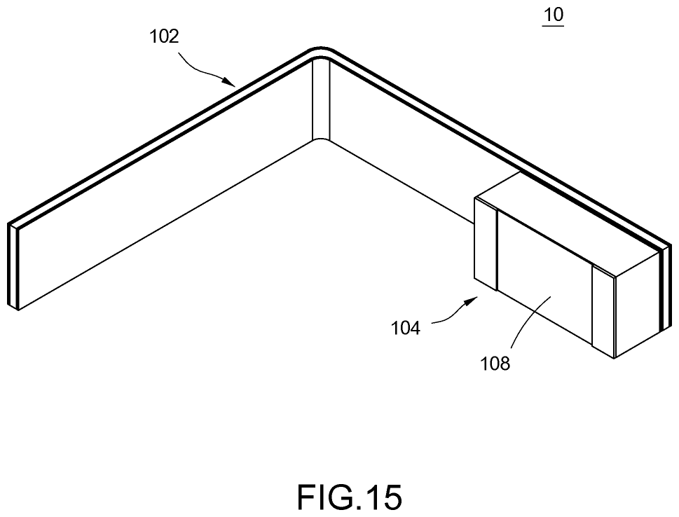

FIG. 1 shows a combined perspective view of the first embodiment of the flexible antenna structure 10 of the present disclosure. Please refer to FIG. 2 at the same time, which shows an exploded view of the first embodiment of the flexible antenna structure 10 of the present disclosure. Please refer to FIG. 14 at the same time, which shows a schematic diagram of the soft board 102 being bent in the first embodiment of the flexible antenna structure 10 of the present disclosure. Please refer to FIG. 15 at the same time, which shows another schematic diagram of the soft board 102 being bent in the first embodiment of the flexible antenna structure of the present disclosure 10. As shown in FIG. 1, FIG. 2, FIG. 14 and FIG. 15, a flexible antenna structure 10 of the present disclosure includes a soft board 102, a first hard board 104, a soft antenna circuit 106 and an antenna substructure 108. The first hard board 104 is arranged on the soft board 102. The soft antenna circuit 106 is arranged on the soft board 102. The antenna substructure 108 is an antenna circuit arranged on the first hard board 104. The soft board 102 may be bent and shaped at any angle. The soft board 102 and the first hard board 104 are combined by a pressing process.

The first embodiment of the flexible antenna structure 10 shown in FIG. 1, FIG. 2, FIG. 14 and FIG. 15 is an asymmetric stack structure. A first material of the soft board 102 is different from a second material of the first hard board 104. The advantage of the first embodiment of the flexible antenna structure 10 shown in FIG. 1, FIG. 2, FIG. 14 and FIG. 15 is that the antenna structure is simple, flexible and easy to arrange, wherein the soft board 102 and the antenna circuit 106 arranged on the soft board 102 are flexible, which can increase the efficiency of space utilization, and have many bending variations.

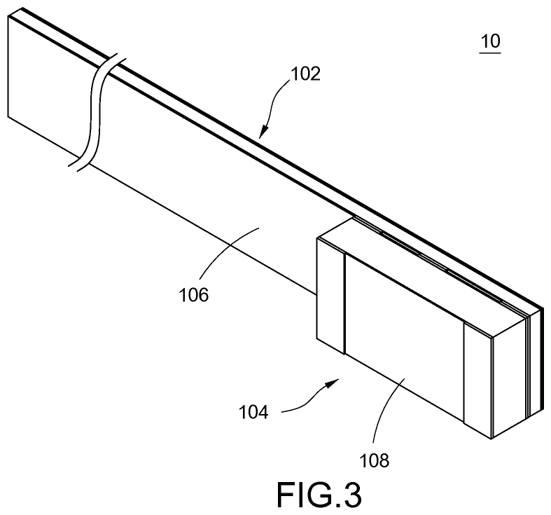

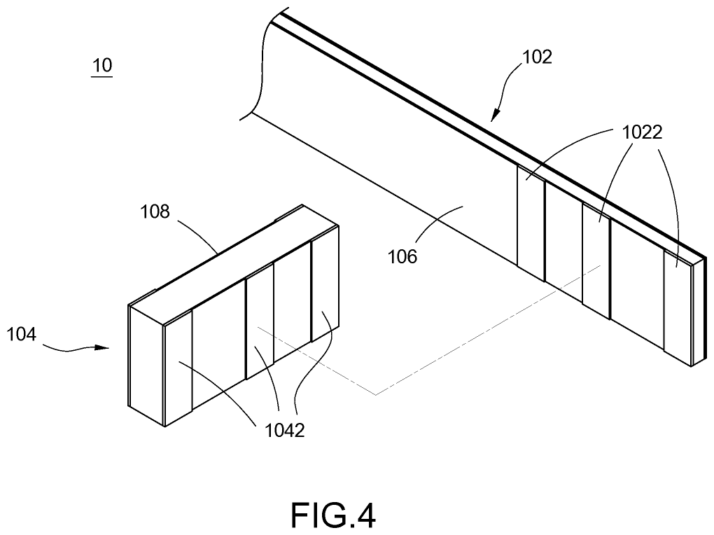

FIG. 3 shows a combined perspective view of the second embodiment of the flexible antenna structure 10 of the present disclosure. Please refer to FIG. 4 at the same time, which shows an exploded view of the second embodiment of the flexible antenna structure 10 of the present disclosure. As shown in FIG. 3 and FIG. 4, a flexible antenna structure 10 of the present disclosure includes a soft board 102, a first hard board 104, a soft antenna circuit 106 and an antenna substructure 108. The soft board 102 includes a plurality of first bonding pads 1022. The first hard board 104 includes a plurality of second bonding pads 1042. The first hard board 104 is arranged on the soft board 102. The soft antenna circuit 106 is arranged on the soft board 102. The antenna substructure 108 is an antenna circuit arranged on the first hard board 104. The first bonding pads 1022 are soldered to the second bonding pads 1042; namely, the soft board 102 and the first hard board 104 are combined by an SMT process.

The second embodiment of the flexible antenna structure 10 shown in FIG. 3 and FIG. 4 is an asymmetric stack structure. A first material of the soft board 102 is different from a second material of the first hard board 104. The advantage of the second embodiment of the flexible antenna structure 10 shown in FIG. 3 and FIG. 4 is that the antenna structure is simple, flexible and easy to arrange, wherein the soft board 102 and the antenna circuit 106 arranged on the soft board 102 are flexible, which can increase the efficiency of space utilization, and have many bending variations.

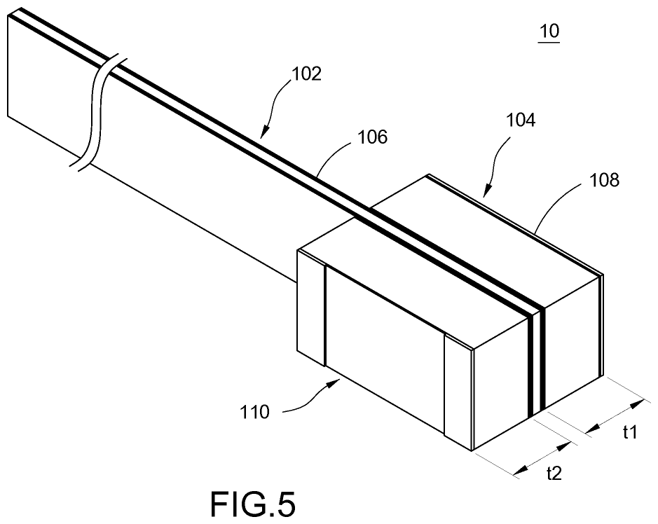

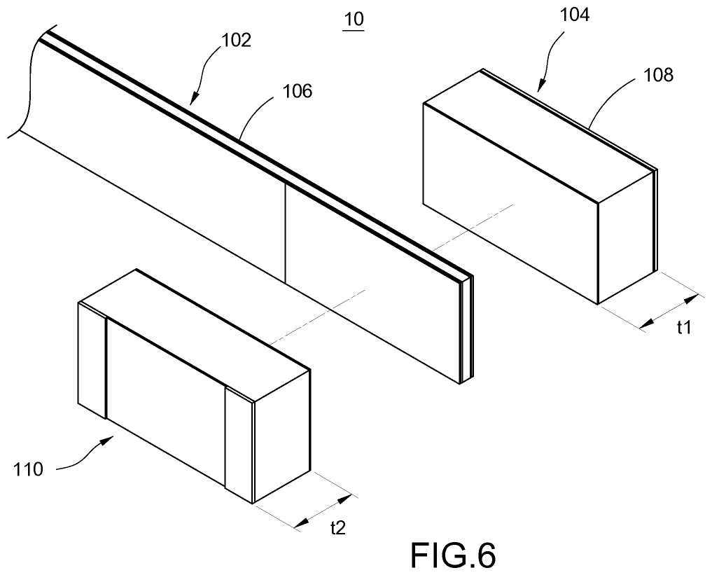

FIG. 5 shows a combined perspective view of the third embodiment of the flexible antenna structure 10 of the present disclosure. Please refer to FIG. 6 at the same time, which shows an exploded view of the third embodiment of the flexible antenna structure 10 of the present disclosure. As shown in FIG. 5 and FIG. 6, a flexible antenna structure 10 of the present disclosure includes a soft board 102, a first hard board 104, a soft antenna circuit 106, an antenna substructure 108 and a second hard board 110. The first hard board 104 is arranged on the soft board 102. The soft antenna circuit 106 is arranged on the soft board 102. The antenna substructure 108 is an antenna circuit arranged on the first hard board 104. The second hard board 110 is arranged on the soft board 102. A first thickness t1 of the first hard board 104 is equal to a second thickness t2 of the second hard board 110.

The third embodiment of the flexible antenna structure 10 shown in FIG. 5 and FIG. 6 is a symmetric stack structure, which is less prone to board bending or board warping. A first material of the soft board 102 is different from a second material of the first hard board 104 and the second hard board 110. The advantage of the third embodiment of the flexible antenna structure 10 shown in FIG. 5 and FIG. 6 is that the antenna structure is simple, flexible and easy to arrange, wherein the soft board 102 and the antenna circuit 106 arranged on the soft board 102 are flexible, which can increase the efficiency of space utilization, and have many bending variations; compared with a ceramic antenna design, the present disclosure can increase the overall antenna radiation efficiency.

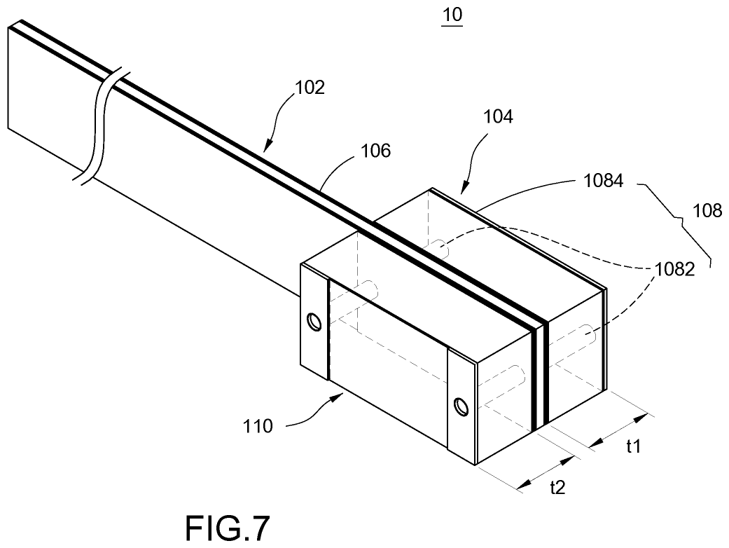

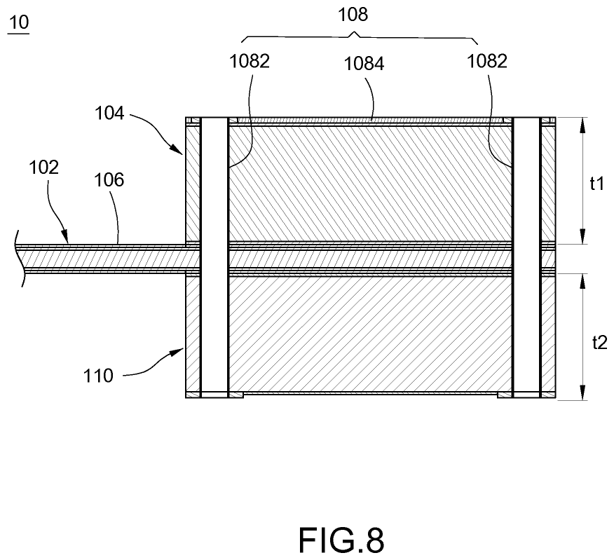

FIG. 7 shows a combined perspective view of the fourth embodiment of the flexible antenna structure 10 of the present disclosure. Please refer to FIG. 8 at the same time, which shows a side sectional view of the fourth embodiment of the flexible antenna structure 10 of the present disclosure. As shown in FIG. 7 and FIG. 8, a flexible antenna structure 10 of the present disclosure includes a soft board 102, a first hard board 104, a soft antenna circuit 106, an antenna substructure 108 and a second hard board 110. The antenna substructure 108 includes a plurality of first via holes 1082 and an antenna circuit 1084. The first hard board 104 is arranged on the soft board 102. The soft antenna circuit 106 is arranged on the soft board 102. The second hard board 110 is arranged on the soft board 102. The first via holes 1082 is defined in the first hard board 104, the soft board 102 and the second hard board 110 to be through the first hard board 104, the soft board 102 and the second hard board 110. The antenna circuit 1084 is arranged on the first hard board 104. A first thickness t1 of the first hard board 104 is equal to a second thickness t2 of the second hard board 110.

The fourth embodiment of the flexible antenna structure 10 shown in FIG. 7 and FIG. 8 is a symmetric stack structure, which is less prone to board bending or board warping. A first material of the soft board 102 is different from a second material of the first hard board 104, and is different from a third material of the second hard board 110. The advantage of the fourth embodiment of the flexible antenna structure 10 shown in FIG. 7 and FIG. 8 is that the antenna structure is simple, flexible and easy to arrange, wherein the soft board 102 and the antenna circuit 106 arranged on the soft board 102 are flexible, which can increase the efficiency of space utilization, and have many bending variations, and can increase an antenna frequency band adjustment variability. Moreover, the fourth embodiment of the flexible antenna structure 10 shown in FIG. 7 and FIG. 8 may not include the antenna circuit 1084 as well.

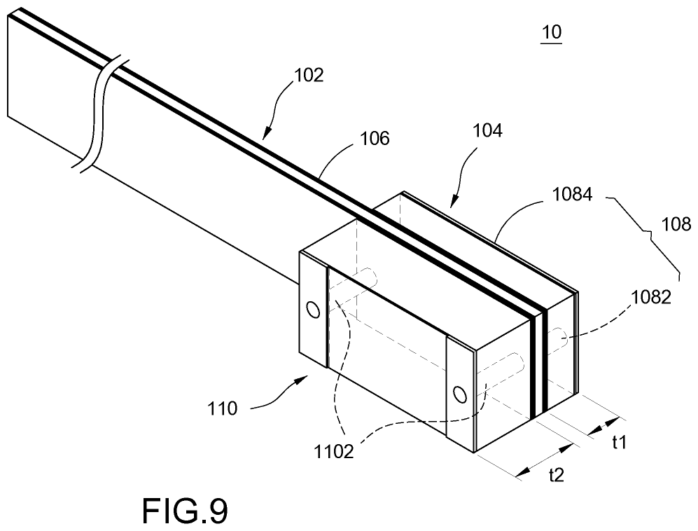

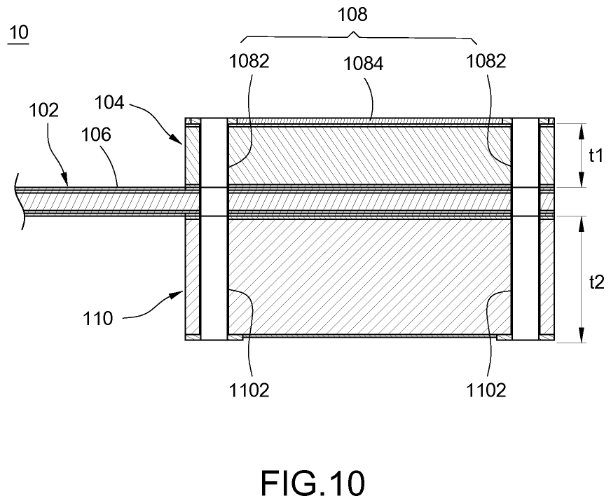

FIG. 9 shows a combined perspective view of the fifth embodiment of the flexible antenna structure 10 of the present disclosure. Please refer to FIG. 10 at the same time, which shows a side sectional view of the fifth embodiment of the flexible antenna structure 10 of the present disclosure. As shown in FIG. 9 and FIG. 10, a flexible antenna structure 10 of the present disclosure includes a soft board 102, a first hard board 104, a soft antenna circuit 106, an antenna substructure 108 and a second hard board 110. The antenna substructure 108 includes a plurality of first via holes 1082 and an antenna circuit 1084. The second hard board 110 defines a plurality of second via holes 1102. The first hard board 104 is arranged on the soft board 102. The soft antenna circuit 106 is arranged on the soft board 102. The second hard board 110 is arranged on the soft board 102. The first via holes 1082 is defined in the first hard board 104. The antenna circuit 1084 is arranged on the first hard board 104. A first thickness t1 of the first hard board 104 is different from a second thickness t2 of the second hard board 110; namely, the first thickness t1 of the first hard board 104 is less than the second thickness t2 of the second hard board 110.

A first material of the soft board 102 of the fifth embodiment of the flexible antenna structure 10 shown in FIG. 9 and FIG. 10 is different from a second material of the first hard board 104, and is different from a third material of the second hard board 110. The advantage of the fifth embodiment of the flexible antenna structure 10 shown in FIG. 9 and FIG. 10 is that the antenna structure is simple, flexible and easy to arrange, wherein the soft board 102 and the antenna circuit 106 arranged on the soft board 102 are flexible, which can increase the efficiency of space utilization, and have many bending variations, and can increase an adaptability to mechanisms and optimize an antenna performance.

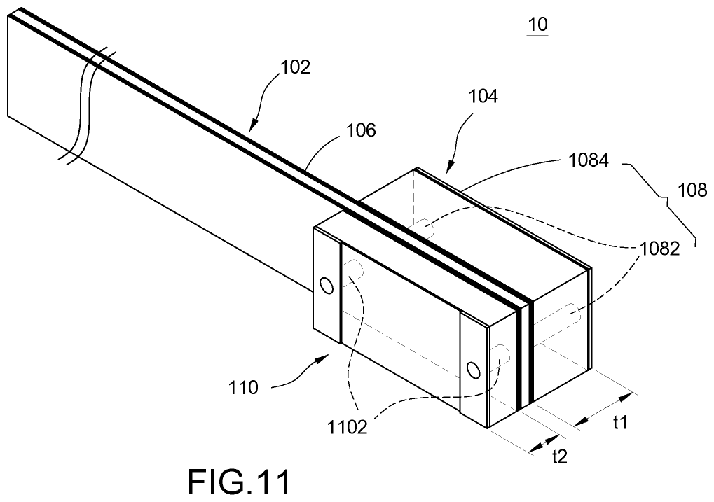

FIG. 11 shows a combined perspective view of the sixth embodiment of the flexible antenna structure 10 of the present disclosure. As shown in FIG. 11, a flexible antenna structure 10 of the present disclosure includes a soft board 102, a first hard board 104, a soft antenna circuit 106, an antenna substructure 108 and a second hard board 110. The antenna substructure 108 includes a plurality of first via holes 1082 and an antenna circuit 1084. The second hard board 110 defines a plurality of second via holes 1102. The first hard board 104 is arranged on the soft board 102. The soft antenna circuit 106 is arranged on the soft board 102. The second hard board 110 is arranged on the soft board 102. The first via holes 1082 is defined in the first hard board 104. The antenna circuit 1084 is arranged on the first hard board 104. A first thickness t1 of the first hard board 104 is different from a second thickness t2 of the second hard board 110; namely, the first thickness t1 of the first hard board 104 is greater than the second thickness t2 of the second hard board 110.

A first material of the soft board 102 of the sixth embodiment of the flexible antenna structure 10 shown in FIG. 11 is different from a second material of the first hard board 104, and is different from a third material of the second hard board 110. The advantage of the sixth embodiment of the flexible antenna structure 10 shown in FIG. 11 is that the antenna structure is simple, flexible and easy to arrange, wherein the soft board 102 and the antenna circuit 106 arranged on the soft board 102 are flexible, which can increase the efficiency of space utilization, and have many bending variations, and can increase an adaptability to mechanisms and optimize an antenna performance.

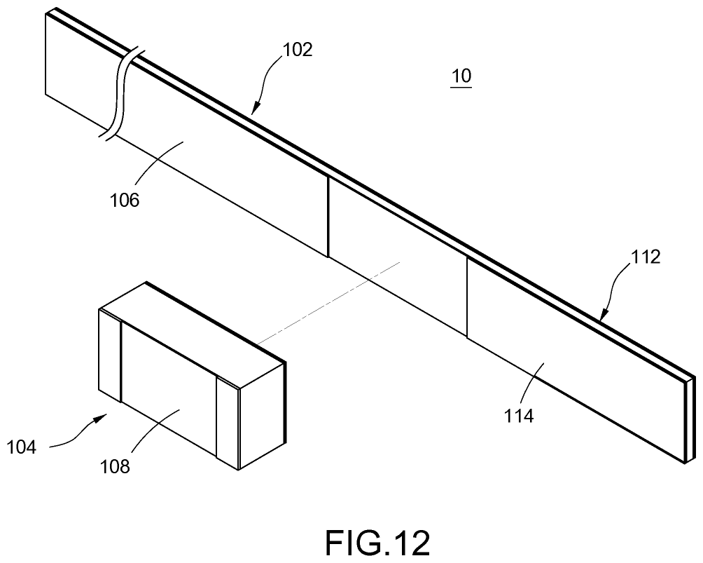

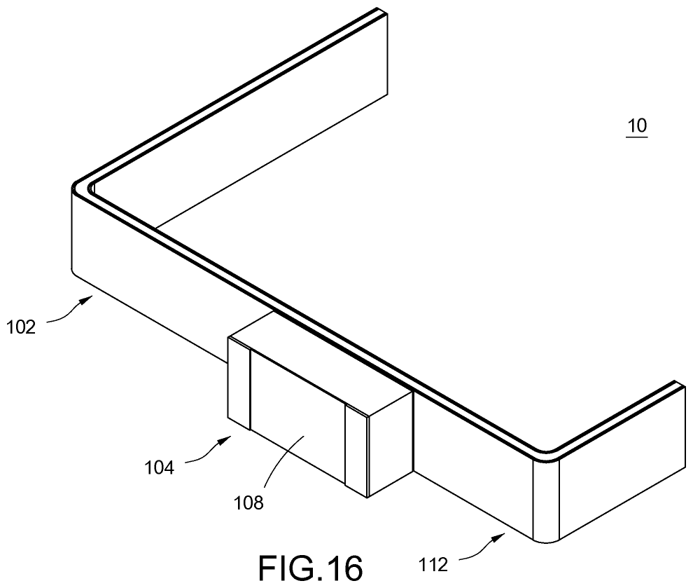

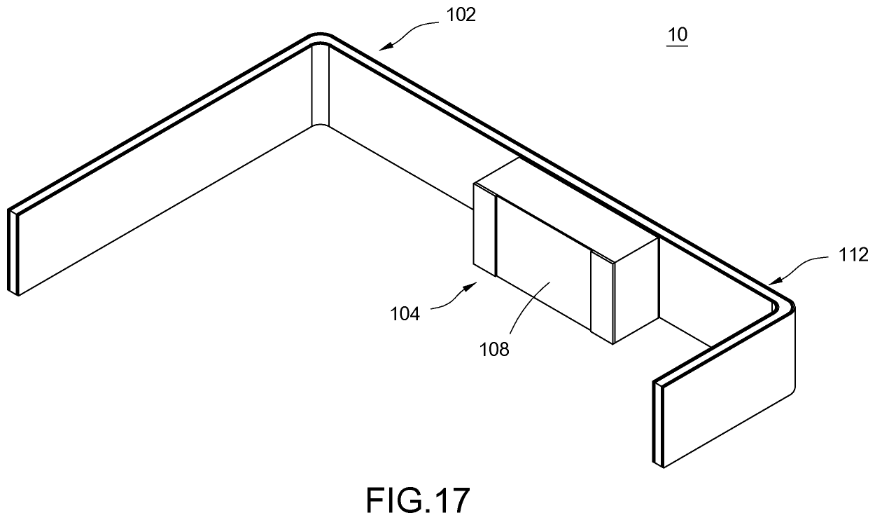

FIG. 12 shows an exploded view of the seventh embodiment of the flexible antenna structure 10 of the present disclosure. Please refer to FIG. 16 at the same time, which shows a schematic diagram of the soft board 102 and the parallelly-extended soft board 112 being bent in the seventh embodiment of the flexible antenna structure 10 of the present disclosure. Please refer to FIG. 17 at the same time, which shows another schematic diagram of the soft board 102 and the parallelly-extended soft board 112 being bent in the seventh embodiment of the flexible antenna structure 10 of the present disclosure. The descriptions of the elements shown in FIG. 12, FIG. 16 and FIG. 17 which are the same as the elements shown in FIG. 1 are not repeated here for brevity.

As shown in FIG. 12, FIG. 16 and FIG. 17, the flexible antenna structure 10 of the present disclosure further includes a parallelly-extended soft board 112 and a first extended soft antenna circuit 114. The parallelly-extended soft board 112 is connected to the soft board 102 to extend parallelly from the soft board 102. The first extended soft antenna circuit 114 is arranged on the parallelly-extended soft board 112. The soft board 102 and the parallelly-extended soft board 112 may be bent and shaped at any angle.

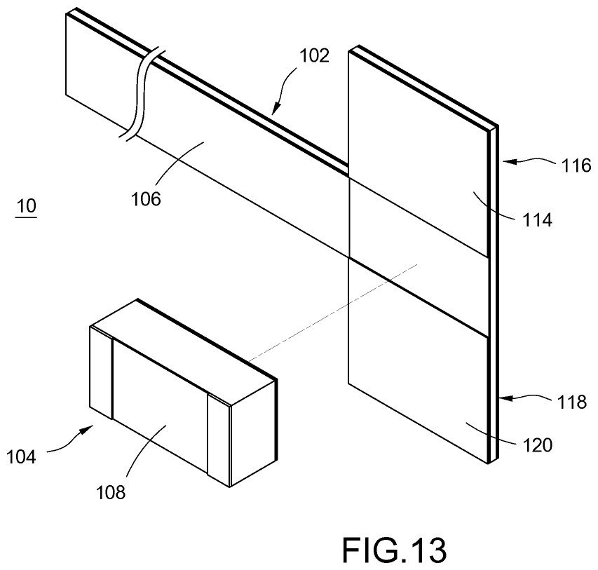

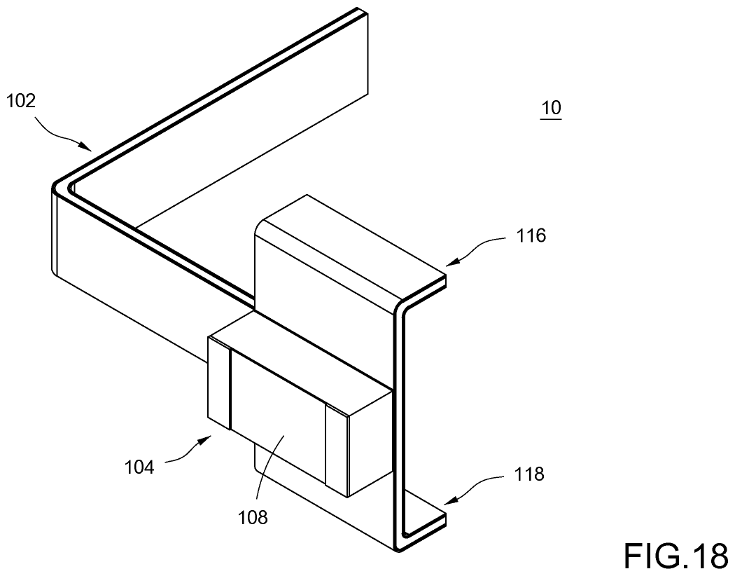

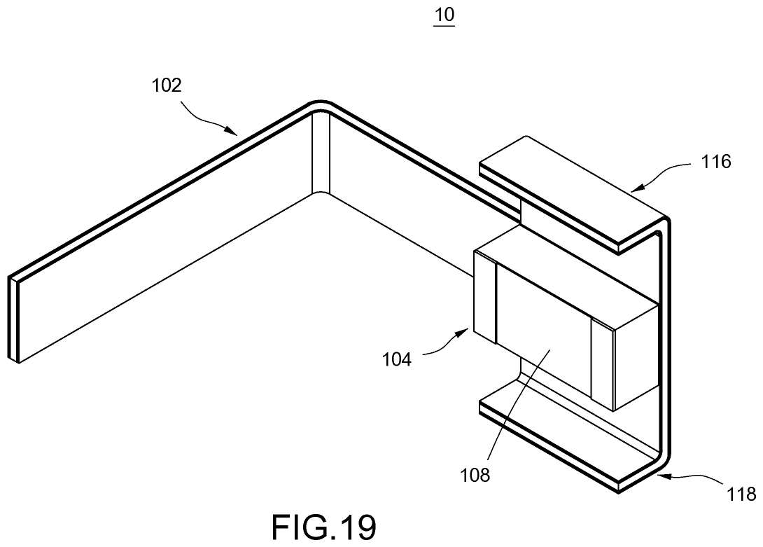

FIG. 13 shows an exploded view of the eighth embodiment of the flexible antenna structure 10 of the present disclosure. Please refer to FIG. 18 at the same time, which shows a schematic diagram of the soft board 102, the first vertically-extended soft board 116 and the second vertically-extended soft board 118 being bent in the eighth embodiment of the flexible antenna structure 10 of the present disclosure. Please refer to FIG. 19 at the same time, which shows another schematic diagram of the soft board 102, the first vertically-extended soft board 116 and the second vertically-extended soft board 118 being bent in the eighth embodiment of the flexible antenna structure 10 of the present disclosure. The descriptions of the elements shown in FIG. 13, FIG. 18 and FIG. 19 which are the same as the elements shown in FIG. 1 are not repeated here for brevity.

As shown in FIG. 13, FIG. 18 and FIG. 19, the flexible antenna structure 10 of the present disclosure further includes a first vertically-extended soft board 116, a first extended soft antenna circuit 114, a second vertically-extended soft board 118 and a second extended soft antenna circuit 120. The first vertically-extended soft board 116 is connected to the soft board 102 to extend vertically from the soft board 102. The first extended soft antenna circuit 114 is arranged on the first vertically-extended soft board 116. The second vertically-extended soft board 118 is connected to the soft board 102 to extend vertically from the soft board 102. The second extended soft antenna circuit 120 is arranged on the second vertically-extended soft board 118. The soft board 102, the first vertically-extended soft board 116 and the second vertically-extended soft board 118 are T-shaped; namely, the soft board 102, the first vertically-extended soft board 116 and the second vertically-extended soft board 118 together form a T shape. The soft board 102, the first vertically-extended soft board 116 and the second vertically-extended soft board 118 may be bent and shaped at any angle.

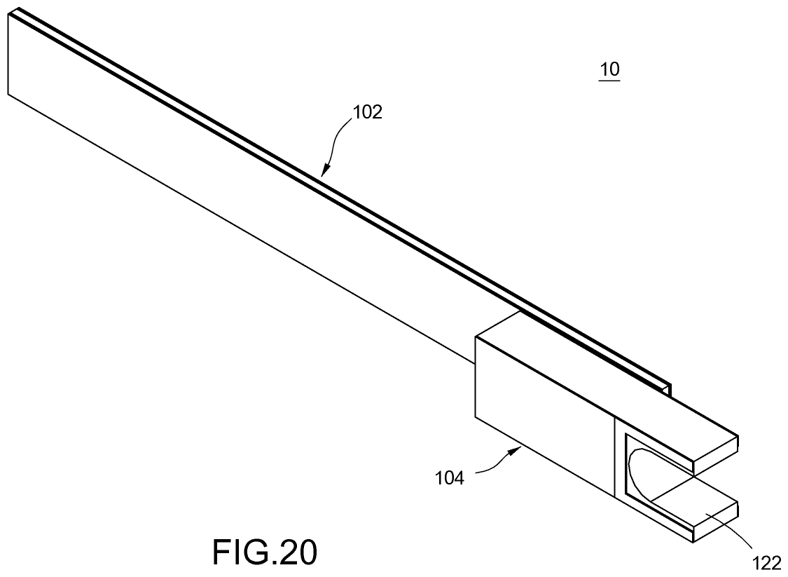

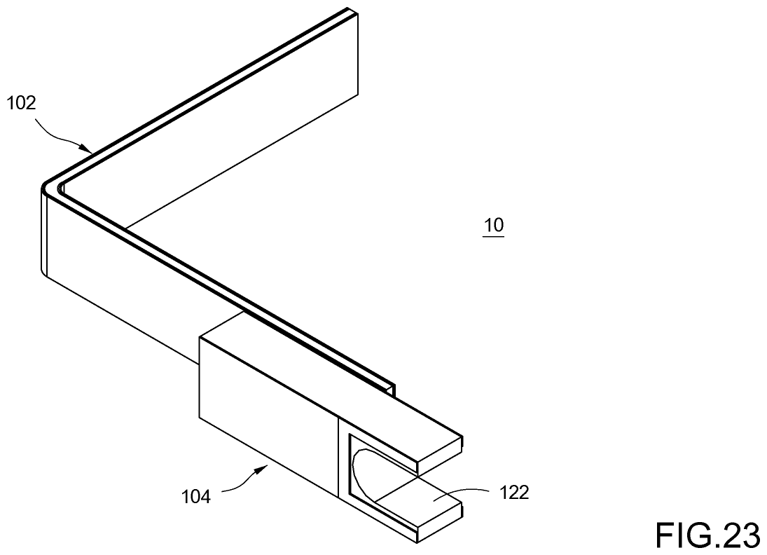

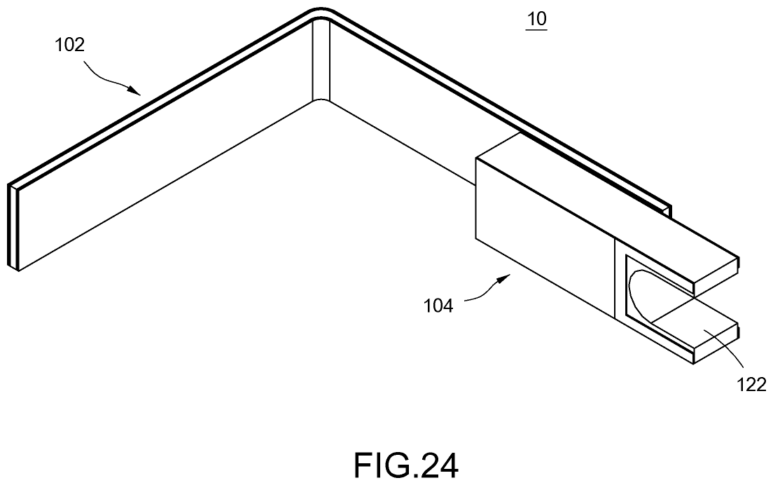

FIG. 20 shows a combined perspective view of the ninth embodiment of the flexible antenna structure 10 of the present disclosure. Please refer to FIG. 23 at the same time, which shows a schematic diagram of the soft board 102 being bent in the ninth embodiment of the flexible antenna structure 10 of the present disclosure. Please refer to FIG. 24 at the same time, which shows another schematic diagram of the soft board 102 being bent in the ninth embodiment of the flexible antenna structure 10 of the present disclosure. The descriptions of the elements shown in FIG. 20, FIG. 23 and FIG. 24 which are the same as the elements shown in FIG. 1 are not repeated here for brevity.

As shown in FIG. 20, FIG. 23 and FIG. 24, the flexible antenna structure 10 of the present disclosure further includes a direct plug structure 122 connected to the first hard board 104. The direct plug structure 122 is U-shaped. With the direct plug structure 122, the flexible antenna structure 10 of the present disclosure can achieve a direct plug antenna inserted into a circuit board (not shown in FIG. 20, FIG. 23 and FIG. 24), and then the soft board 102 can be extended, adjusted and bent according to a required field pattern.

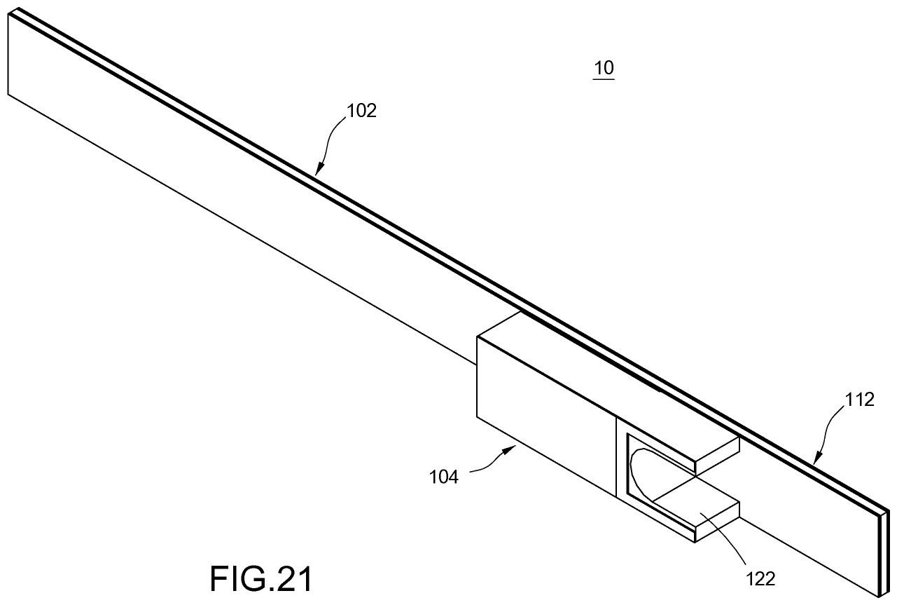

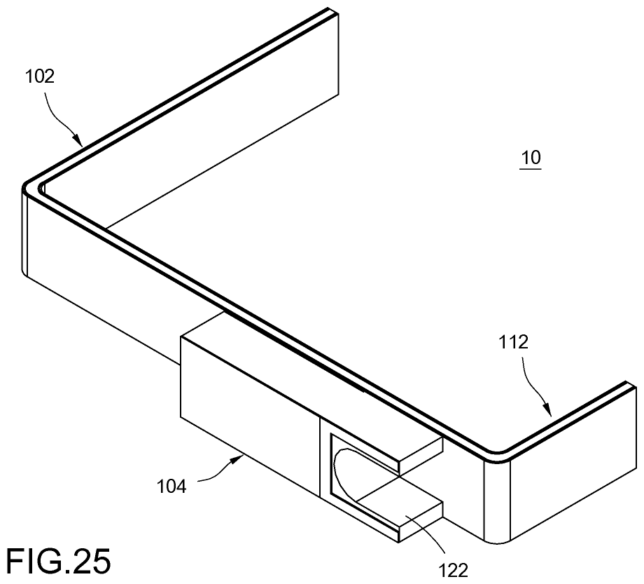

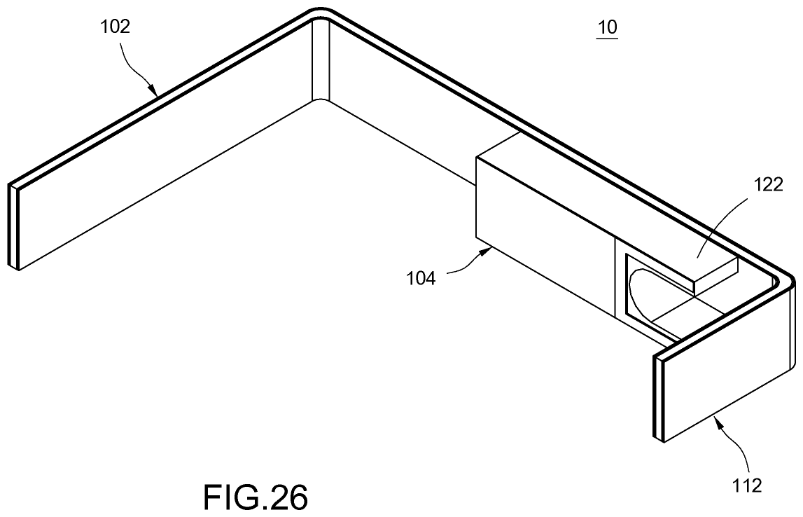

FIG. 21 shows a combined perspective view of the tenth embodiment of the flexible antenna structure 10 of the present disclosure. Please refer to FIG. 25 at the same time, which shows a schematic diagram of the soft board 102 and the parallelly-extended soft board 112 being bent in the tenth embodiment of the flexible antenna structure 10 of the present disclosure. Please refer to FIG. 26 at the same time, which shows another schematic diagram of the soft board 102 and the parallelly-extended soft board 112 being bent in the tenth embodiment of the flexible antenna structure 10 of the present disclosure. The descriptions of the elements shown in FIG. 21, FIG. 25 and FIG. 26 which are the same as the elements shown in FIG. 12 are not repeated here for brevity.

As shown in FIG. 21, FIG. 25 and FIG. 26, the flexible antenna structure 10 of the present disclosure further includes a direct plug structure 122 connected to the first hard board 104. The direct plug structure 122 is U-shaped. With the direct plug structure 122, the flexible antenna structure 10 of the present disclosure can achieve a direct plug antenna inserted into a circuit board (not shown in FIG. 21, FIG. 25 and FIG. 26), and then the soft board 102 and the parallelly-extended soft board 112 can be extended, adjusted and bent according to a required field pattern.

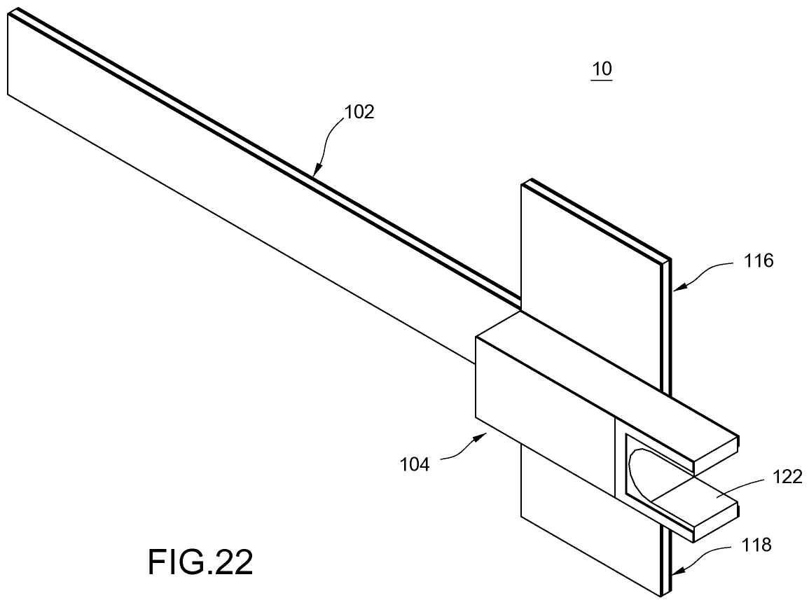

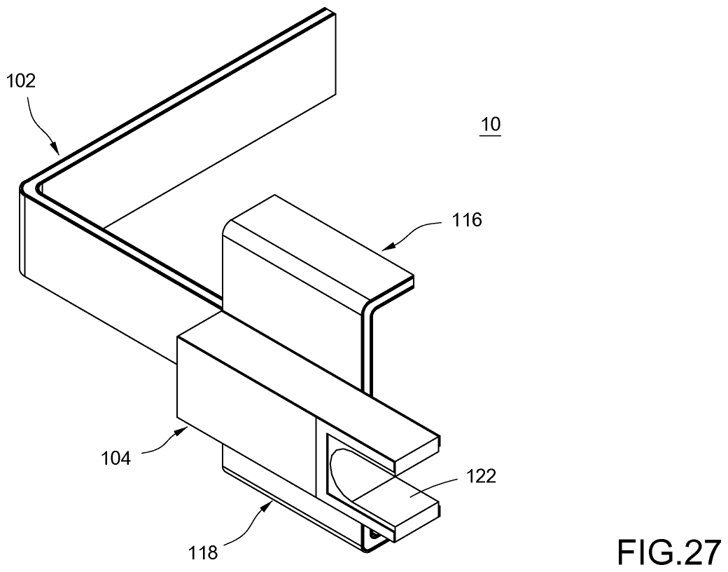

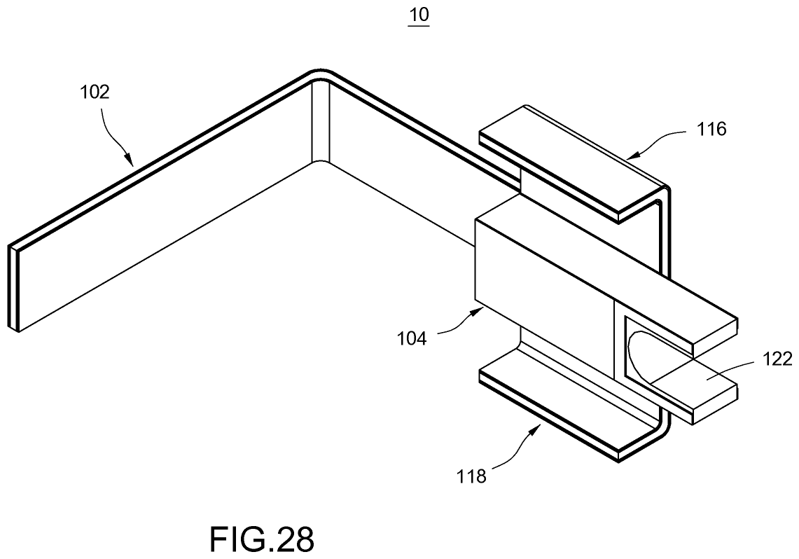

FIG. 22 shows a combined perspective view of the eleventh embodiment of the flexible antenna structure 10 of the present disclosure. Please refer to FIG. 27 at the same time, which shows a schematic diagram of the soft board 102, the first vertically-extended soft board 116 and the second vertically-extended soft board 118 being bent in the eleventh embodiment of the flexible antenna structure 10 of the present disclosure. Please refer to FIG. 28 at the same time, which shows another schematic diagram of the soft board 102, the first vertically-extended soft board 116 and the second vertically-extended soft board 118 being bent in the eleventh embodiment of the flexible antenna structure 10 of the present disclosure. The descriptions of the elements shown in FIG. 22, FIG. 27 and FIG. 28 which are the same as the elements shown in FIG. 13 are not repeated here for brevity.

As shown in FIG. 22, FIG. 27 and FIG. 28, the flexible antenna structure 10 of the present disclosure further includes a direct plug structure 122 connected to the first hard board 104. The direct plug structure 122 is U-shaped. With the direct plug structure 122, the flexible antenna structure 10 of the present disclosure can achieve a direct plug antenna inserted into a circuit board (not shown in FIG. 22, FIG. 27 and FIG. 28), and then the soft board 102, the first vertically-extended soft board 116 and the second vertically-extended soft board 118 can be extended, adjusted and bent according to a required field pattern.

Although the present disclosure has been described with reference to the embodiment thereof, it will be understood that the disclosure is not limited to the details thereof. Various substitutions and modifications have been suggested in the foregoing description, and others will occur to those of ordinary skill in the art. Therefore, all such substitutions and modifications are intended to be embraced within the scope of the disclosure as defined in the appended claims.

What is claimed is:

1. A flexible antenna structure comprising:
a soft board;
a first hard board arranged on the soft board;
a soft antenna circuit arranged on the soft board; and
an antenna substructure arranged on the first hard board or defined in the first hard board.

2. The flexible antenna structure of claim 1, wherein the antenna substructure is an antenna circuit arranged on the first hard board.

3. The flexible antenna structure of claim 2, wherein the soft board comprises a plurality of first bonding pads; the first hard board comprises a plurality of second bonding pads; the first bonding pads are soldered to the second bonding pads.

4. The flexible antenna structure of claim 2, further comprising:
a second hard board arranged on the soft board,
wherein a first thickness of the first hard board is equal to a second thickness of the second hard board.

5. The flexible antenna structure of claim 1, further comprising:
a second hard board arranged on the soft board,
wherein the antenna substructure comprises:
a plurality of first via holes defined in the first hard board, the soft board and the second hard board to be through the first hard board, the soft board and the second hard board.

6. The flexible antenna structure of claim 5, wherein the antenna substructure further comprises:
an antenna circuit arranged on the first hard board.

7. The flexible antenna structure of claim 6, wherein a first thickness of the first hard board is equal to a second thickness of the second hard board.

8. The flexible antenna structure of claim 1, further comprising:
a second hard board arranged on the soft board,
wherein the antenna substructure comprises:
a plurality of first via holes defined in the first hard board,
wherein the second hard board defines a plurality of second via holes.

9. The flexible antenna structure of claim 8, wherein the antenna substructure further comprises:
an antenna circuit arranged on the first hard board.

10. The flexible antenna structure of claim 9, wherein a first thickness of the first hard board is different from a second thickness of the second hard board.

11. The flexible antenna structure of claim 1, wherein the soft board is bent and shaped at any angle.

12. The flexible antenna structure of claim 1, further comprising:
a parallelly-extended soft board connected to the soft board to extend parallelly from the soft board; and
a first extended soft antenna circuit arranged on the parallelly-extended soft board.

13. The flexible antenna structure of claim 12, wherein the soft board and the parallelly-extended soft board are bent and shaped at any angle.

14. The flexible antenna structure of claim 1, further comprising:
a first vertically-extended soft board connected to the soft board to extend vertically from the soft board;
a first extended soft antenna circuit arranged on the first vertically-extended soft board;
a second vertically-extended soft board connected to the soft board to extend vertically from the soft board; and
a second extended soft antenna circuit arranged on the second vertically-extended soft board,
wherein the soft board, the first vertically-extended soft board and the second vertically-extended soft board together form a T shape.

15. The flexible antenna structure of claim 14, wherein the soft board, the first vertically-extended soft board and the second vertically-extended soft board are bent and shaped at any angle.

16. The flexible antenna structure of claim 1, further comprising:
a direct plug structure connected to the first hard board.

17. The flexible antenna structure of claim 16, wherein the direct plug structure is U-shaped.
